(19) United States
(12) Patent Application Publication
(10) Pub. No.: US 2026/0080013 A1
(43) Pub. Date: Mar. 19, 2026

(54) LANGUAGE MODEL POWERED SEARCH ON STRUCTURED RECORDS USING RELATIONSHIP GRAPHS

(71) Applicant: Schlumberger Technology Corporation, Sugar Land, TX (US)

(72) Inventors: Prashanth Pillai, Pune (IN); Avinash Lokhande, Pune (IN); RITIK SHRIVASTAVA, Pune (IN); Mohd Saood Shakeel, Pune (IN)

(21) Appl. No.: 19/301,566

(22) Filed: Aug. 15, 2025

(30) Foreign Application Priority Data
Sep. 13, 2024 (IN) 202411069443

(51) Int. Cl. G06F 16/9032; G06F 16/21; G06F 16/2452; G06F 16/248; G06F 16/901

(52) U.S. Cl. CPC G06F 16/90332; G06F 16/212; G06F 16/2452; G06F 16/248; G06F 16/9024

(57) ABSTRACT

A method implements language model powered search on structured records using relationship graphs. A relationship graph representing entity relationships among a set of tables in a database based on multiple schema definitions is constructed. A structured query based on the natural language query and the multiple schema definitions is generated. The structured query is deconstructed to extract a source table of the set of tables, a target table of the set of tables, a query condition, and an aggregation operator. A traversal path is determined across the relationship graph based on the source table and the target table. A set of entity-specific queries are executed using the query condition and the traversal path to retrieve records from the database. A response is generated based on the retrieved records and the aggregation operator. The response includes one or more of a textual summary and a visualization based on the output prompt.

### CROSS-REFERENCE TO RELATED APPLICATIONS

This application claims the benefit of India Provisional Application 20/241,1069443, filed Sep. 13, 2024, with the Office of the Controller General of Patents, Designs and Trade Marks (CGPDTM) of India, which is incorporated by reference herein.

### BACKGROUND

Standardized data schemas structure complex and interrelated information in large-scale data systems across domains such as energy exploration. Schema specifications define entities including wells, wellbores, logs, and markers, which are stored in data platforms such as the Open Subsurface Data Universe (OSDU). Search and analytics engines may be used in the large-scale data systems for indexing and search operations. Search and analytics engines may perform full-text search and high-speed retrieval across large volumes of structured and semi-structured data. Schema-based organization and indexing facilitate access to domain-specific data models.

Natural language interfaces interact with structured data systems through semantic parsing and query translation. Semantic parsing technologies convert natural language input into structured query languages, such as Structured Query Language (SQL) or domain-specific formats. The process may involve mapping linguistic expressions to schema-defined entities and attributes, interpreting intent, and generating syntactically valid queries. Schema metadata and inter-entity relationships may inform the structure and logic of the resulting queries.

### SUMMARY

In general, in one or more aspects, the disclosure relates to a method for language model powered search on structured records using relationship graphs. The method involves constructing, by a language model executing a relationship graph construction prompt, a relationship graph representing entity relationships among a set of tables in a database based on multiple schema definitions. The method further involves generating, by the language model executing a query construction prompt, a structured query based on the natural language query and the multiple schema definitions. The method further involves deconstructing the structured query to extract a source table of the set of tables, a target table of the set of tables, a query condition, and an aggregation operator. The method further involves determining, by the language model executing an action planning prompt, a traversal path across the relationship graph based on the source table and the target table. The method further involves executing a set of entity-specific queries using the query condition and the traversal path to retrieve records from the database. The method further involves generating, by the language model executing an output prompt, a response based on the retrieved records and the aggregation operator. The response includes one or more of a textual summary and a visualization based on the output prompt.

In general, in one or more aspects, the disclosure relates to a system that includes at least one processor and an application that executes on the at least one processor. Executing the application performs constructing, by a language model executing a relationship graph construction prompt, a relationship graph representing entity relationships among a set of tables in a database based on multiple schema definitions. Executing the application further performs generating, by the language model executing a query construction prompt, a structured query based on the natural language query and the multiple schema definitions. Executing the application further performs deconstructing the structured query to extract a source table of the set of tables, a target table of the set of tables, a query condition, and an aggregation operator. Executing the application further performs determining, by the language model executing an action planning prompt, a traversal path across the relationship graph based on the source table and the target table. Executing the application further performs executing a set of entity-specific queries using the query condition and the traversal path to retrieve records from the database. Executing the application further performs generating, by the language model executing an output prompt, a response based on the retrieved records and the aggregation operator. The response includes one or more of a textual summary and a visualization based on the output prompt.

In general, in one or more aspects, the disclosure relates to a non-transitory computer readable medium including instructions executable by at least one processor. Executing the instructions performs constructing, by a language model executing a relationship graph construction prompt, a relationship graph representing entity relationships among a set of tables in a database based on multiple schema definitions. Executing the instructions further performs generating, by the language model executing a query construction prompt, a structured query based on the natural language query and the multiple schema definitions. Executing the instructions further performs deconstructing the structured query to extract a source table of the set of tables, a target table of the set of tables, a query condition, and an aggregation operator. Executing the instructions further performs determining, by the language model executing an action planning prompt, a traversal path across the relationship graph based on the source table and the target table. Executing the instructions further performs executing a set of entity-specific queries using the query condition and the traversal path to retrieve records from the database. Executing the instructions further performs generating, by the language model executing an output prompt, a response based on the retrieved records and the aggregation operator. The response includes one or more of a textual summary and a visualization based on the output prompt.

Other aspects of one or more embodiments may be apparent from the following description and the appended claims.

### BRIEF DESCRIPTION OF DRAWINGS

FIG. 1 shows a diagram in accordance with the disclosure.

FIG. 2 shows a method in accordance with the disclosure.

FIG. 3, FIG. 4, FIG. 5, and FIG. 6 show examples in accordance with the disclosure.

FIG. 7.1 and FIG. 7.2 show computing systems in accordance with the disclosure.

Similar elements in the various figures may be denoted by similar names and reference numerals. The details of the features and elements described in one figure may extend to similarly named features and elements in different figures.

### DETAILED DESCRIPTION

Embodiments of the disclosure implement language model powered search on structured records using relationship graphs. Structured data systems in domains such as energy exploration may rely on non-relational data platforms that lack native support for relational operations. Search and analytics engines, e.g., Elasticsearch built on Apache Lucene, perform high-speed indexing and retrieval but may not implement join operations across related entities. In environments where data is distributed across multiple schema-defined entities, the absence of native join capabilities introduces complexity in retrieving meaningful, cross-entity insights. Application-level logic may be constructed to simulate relational behavior, which increases implementation overhead and introduces potential for inconsistency and inefficiency.

An entity, in the context of structured data systems, refers to a distinct object or concept represented within a data model. Each entity is defined by a schema that specifies attributes, data types, and structural constraints. Entities serve as the primary organizational units in schema-based systems and are used to model real-world objects, processes, or classifications. Examples of entities in general domains include customers, transactions, products, documents, locations, etc. Entities may be stored as collections of records, where each record conforms to the schema associated with that entity.

In the Open Subsurface Data Universe (OSDU) platform, entities represent domain-specific objects relevant to subsurface data management in the energy sector. The OSDU schema defines entities such as wells, wellbores, logs, markers, trajectories, and production data. Each of the entities is described using a standardized schema that captures the relevant attributes and relationships to other entities. For example, a wellbore entity may reference a parent well entity and be associated with one or more log entities. The structured definitions allow OSDU to support consistent data ingestion, indexing, and retrieval across a wide range of subsurface data types.

Natural language interfaces are used to simplify access to structured databases. Conventional semantic parsing systems of natural language interfaces face limitations when applied to domain-specific schemas with complex inter-entity relationships. To perform the conversion, accurate interpretation of schema definitions and relationship hierarchies forms the basis for mapping natural language input to structured queries. Without a mechanism to incorporate schema context and relationship logic into the parsing process, generated queries may lack syntactic or semantic validity. Effective query construction in such environments may utilize linguistic understanding and structural awareness of the data model.

One or more embodiments of the disclosure address the challenges identified above by introducing a system that integrates schema definitions, relationship graphs, and structured query generation into a unified framework. A language model is applied in multiple roles to construct relationship graphs, generate structured queries, plan traversal paths across related entities, and produce outputs in textual or visual form. Retrieval-augmented generation (RAG) techniques may be incorporated to manage large schema contexts by dynamically selecting relevant schema fragments. System of the disclosure may operate across simple and complex data environments, adapting to schema scale and query complexity without reliance on native relational features.

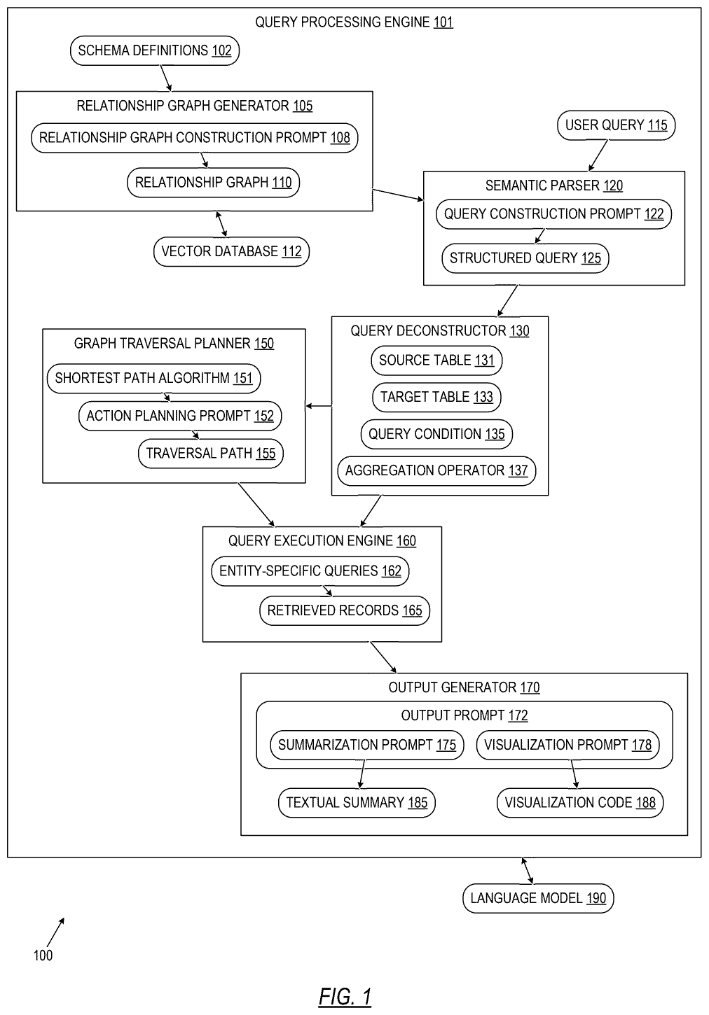

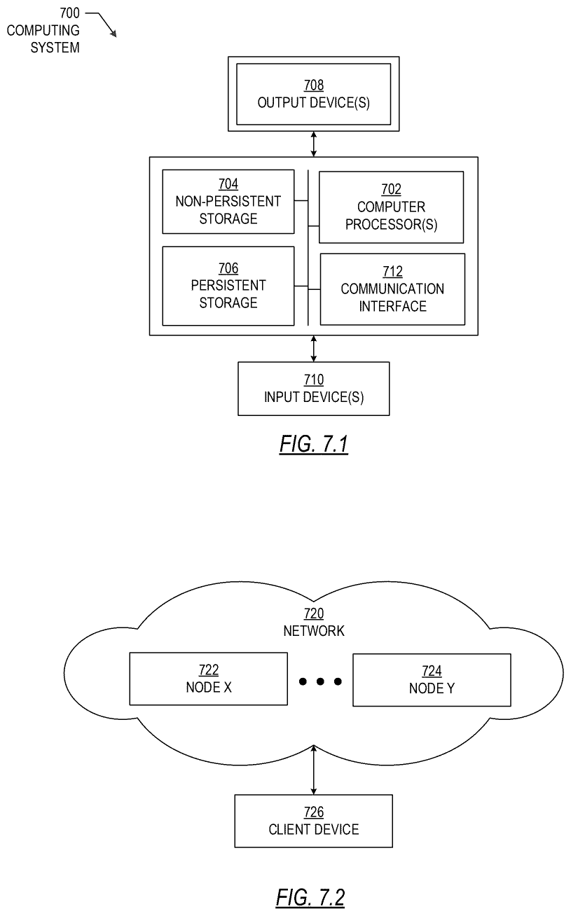

Turning to FIG. 1, the components (100) are a set of integrated modules configured to process natural language queries against structured data organized under schema-based models. The components (100) may operate as part of the computing system (700) of FIG. 7.1 and may include both software and hardware elements arranged to support modular query interpretation and response generation. The components (100) include the query processing engine (101), which coordinates the flow of data and control signals across the system. The components (100) also include the language model (190), which executes prompts associated with query construction, action planning, summarization, visualization, etc. A language model (190) is a machine learning model that is configured to perform natural language understanding, processing, and generation. The language model may be a large language model as known in the art. The components (100) form the architectural foundation for the system described in the claimed embodiments and serve as the operational framework for language model powered search on structured records using relationship graphs.

The query processing engine (101) is one of the components (100) configured to manage the end-to-end flow of data and control logic for processing natural language queries. The query processing engine (101) may operate as a software module, a set of services, a combination of both, etc. The query processing engine (101) receives a user query (115) and coordinates the invocation of downstream modules responsible for interpreting schema definitions, constructing structured queries, and generating outputs. The query processing engine (101) interfaces with the language model (190) to execute prompt-based tasks such as query construction, action planning, summarization, visualization, etc. The query processing engine (101) manages the sequencing and data exchange between internal components, including schema access, prompt execution, query transformation, and result formatting. The query processing engine (101) may include internal state management, logging, and orchestration logic to support consistent and traceable query execution across varying schema complexities and data volumes. The query processing engine (101) serves as the operational coordinator and governs the structured interaction between user input, schema context, and language model output.

The schema definitions (102) are structured representations of data models used to describe the organization, attributes, and relationships of entities within a structured data system. The schema definitions (102) may be stored in a persistent data store or accessed dynamically from a schema registry. The schema definitions (102) specify the fields, data types, constraints, and metadata associated with each entity, such as wells, wellbores, logs, markers, etc. The schema definitions (102) may include hierarchical, or nested structures, and may reference other schema definitions to express inter-entity relationships. The schema definitions (102) may be formatted in JavaScript Object Notation (JSON), Extensible Markup Language (XML), YAML Ain't Markup Language (YAML), or other machine-readable formats suitable for parsing and interpretation by automated systems. The schema definitions (102) provide structural context for interpreting user queries, constructing valid structured queries, and aligning query logic with the underlying data model.

The relationship graph generator (105) is a processing module configured to derive inter-entity relationships from the schema definitions (102) and construct the relationship graph (110) that represents the relationships in a structured form. The relationship graph generator (105) may operate as part of the computing system (700) of FIG. 7.1 and may be implemented as a standalone service, a callable function, a containerized component, etc. The relationship graph generator (105) receives schema metadata describing entities such as wells, wellbores, logs, markers, etc., and analyzes references, foreign key associations, and structural dependencies to infer directed or undirected relationships. The relationship graph generator (105) may represent the resulting graph using adjacency lists, edge lists, matrix representations, or other graph data structures suitable for traversal and reasoning. The relationship graph generator (105) produces the relationship graph (110), which may be stored in memory, persisted in a graph database, or serialized in formats such as JavaScript Object Notation (JSON), Extensible Markup Language (XML), YAML Ain′t Markup Language (YAML), etc. The relationship graph generator (105) supports downstream processing by providing a formalized representation of the connections of entities, which may be used in the graph traversal planner (150), the query construction prompt (122), the action planning prompt (152), etc.

The relationship graph construction prompt (108) is a prompt input configured to instruct the language model (190) to generate the relationship graph (110) based on the schema definitions (102). The relationship graph construction prompt (108) may be implemented as a structured text template, a parameterized instruction, a serialized object, etc. The relationship graph construction prompt (108) may include schema metadata, entity descriptions, attribute references, and relationship indicators formatted in JavaScript Object Notation (JSON), Extensible Markup Language (XML), YAML Ain′t Markup Language (YAML), etc. The relationship graph construction prompt (108) is designed to guide the language model (190) in identifying entity relationships, such as parent-child links, foreign key associations, containment hierarchies, etc., based on the structural information present in the schema definitions (102). The relationship graph construction prompt (108) may be dynamically generated or retrieved from a prompt library and may be adapted to reflect the complexity, scale, and domain-specific characteristics of the schema. The relationship graph construction prompt (108) serves as the initiating instruction for the generation of the relationship graph (110) and contributes to the formalization of the inter-entity structure within schema-based data environments.

The relationship graph (110) is a structured representation of inter-entity relationships derived from the schema definitions (102). The relationship graph (110) models the logical connections among entities such as wells, wellbores, logs, markers, etc., based on references, foreign key associations, containment structures, and other schema-level indicators. As an example, a relationship graph may store a particular relationship from a particular well to the particular wellsite for multiple wells and wellsites. The relationship graph (110) may be implemented using graph data structures such as adjacency lists, edge lists, or matrices, and may be stored in memory, persisted in a graph database, or serialized in formats such as JavaScript Object Notation (JSON), Extensible Markup Language (XML), YAML Ain′t Markup Language (YAML), etc. The relationship graph (110) may include directed or undirected edges, labeled nodes, and metadata annotations to support traversal, filtering, and reasoning operations. The relationship graph (110) represents the structural and semantic connections among entities defined in the schema and may be used to inform query planning, traversal logic, and prompt construction in systems that operate on schema-based data models. The relationship graph (110) provides a machine-readable format for expressing interconnections among entities within a domain-specific data environment.

The vector database (112) is a data structure configured to store and retrieve vector embeddings derived from schema definitions and relationship graph schema. The vector database (112) may be implemented using specialized vector search engines such as FAISS, Milvus, Weaviate, Vespa, etc., or integrated into hybrid systems that combine vector and metadata indexing. The vector database (112) stores high-dimensional vector representations of schema elements, including entity names, attribute descriptions, and inter-entity relationships, which are generated using embedding models such as BERT, Sentence-BERT, domain-specific transformers, etc. The vector database (112) supports similarity-based retrieval operations by comparing the embedding of a user query against stored embeddings to identify semantically relevant schema fragments. The vector database (112) may be queried by a retriever module that computes the embedding of a user query and performs a nearest-neighbor search using cosine similarity, dot product, or other distance metrics. The vector database (112) returns a ranked list of schema definitions and relationship graph segments that are most relevant to the user query, which are used as input context for the query construction prompt. The vector database (112) may be periodically updated to reflect changes in schema definitions or relationship structures and may support versioning, sharding, and distributed indexing for scalability. The vector database (112) provides a mechanism for retrieval-augmented generation in systems where the full schema context exceeds the input capacity of a language model. The vector database (112) enhances the precision and relevance of structured query generation by grounding the language model in dynamically retrieved schema context. The vector database (112) operates as a semantic memory layer that bridges natural language input with structured schema knowledge in large-scale data environments.

The user query (115) is a natural language input that initiates the query processing workflow within the system. The user query (115) may be expressed in free-form text and may include references to entities, attributes, conditions, aggregation intents, temporal constraints, spatial filters, etc. The user query (115) is received by the semantic parser (120) and is used to infer the informational intent of the user in the context of the underlying schema definitions and relationship graph schema. The user query (115) may be processed in isolation or in conjunction with prior conversational turns to support multi-turn interactions and context-aware reasoning. The user query (115) may be embedded using a language model to generate a vector representation that is compared against stored embeddings in the vector database to retrieve relevant schema fragments. The user query (115) may be parsed to identify candidate entity types, attribute references, and logical conditions that inform the construction of a structured query. The user query (115) may be used to guide the selection of relevant schema definitions, relationship paths, and query operators that are used to retrieve and process structured records. The user query (115) may be logged, tokenized, and annotated for downstream processing, including prompt construction, query deconstruction, output generation, etc. The user query (115) serves as the input for natural language interaction with structured data systems and provides the semantic foundation for subsequent query interpretation and execution.

The semantic parser (120) is a processing module configured to interpret a user query (115) and generate a structured representation of the query intent. The semantic parser (120) may be implemented as a software component, a callable service, a containerized function, etc., and may operate within a query processing engine or as a standalone module. The semantic parser (120) receives the user query (115) and applies natural language understanding techniques to extract semantic elements such as entity types, attribute references, logical conditions, aggregation intents, temporal constraints, spatial filters, etc. The semantic parser (120) may invoke the language model (190) using a query construction prompt (122) to translate the user query (115) into a structured query format such as SQL, MongoDB query language, or a domain-specific query language. The semantic parser (120) may incorporate conversational history, schema definitions, and relationship graph schema as contextual inputs to improve the accuracy and relevance of the structured query. The semantic parser (120) may operate in conjunction with a retriever module that selects relevant schema fragments from a vector database based on semantic similarity to the user query (115). The semantic parser (120) may output a structured query that conforms to the syntax and semantics of the target data platform and that serves as input to downstream components such as a query deconstructor or a graph traversal planner. The semantic parser (120) may support multi-turn interactions, ambiguity resolution, and domain-specific reasoning by leveraging prompt engineering, context management, and language model capabilities. The semantic parser (120) provides an initial transformation layer that bridges natural language input with structured query logic in schema-based data environments.

The query construction prompt (122) is a prompt input configured to instruct the language model (190) to generate the structured query (125) based on the user query (115). The query construction prompt (122) may be implemented as a parameterized instruction, a dynamic prompt string, a serialized object, etc., and may be constructed at runtime or retrieved from a prompt library. The query construction prompt (122) may include the user query (115), the schema definitions (102), a relationship graph schema for the relationship graph (110), a conversational history, retrieved schema fragments from the vector database (112), etc., as contextual inputs. The query construction prompt (122) may be formatted to elicit structured query output in a target language such as SQL, MongoDB query language, Gremlin, Cypher, etc., or in a domain-specific query language. The query construction prompt (122) may specify syntactic constraints, formatting rules, and structural expectations to guide the language model (190) in generating a valid and executable version of the structured query (125). The query construction prompt (122) may incorporate examples, schema-specific hints, or domain-specific terminology to improve alignment between the user query (115) and the structured query (125). The query construction prompt (122) may be used in both single-turn and multi-turn interactions and may be adapted to reflect the complexity of the schema, the specificity of the user query (115), and the capabilities of the target data platform. The query construction prompt (122) functions as a mechanism for translating natural language intent into the structured query (125) within schema-based data environments.

The structured query (125) is a machine-generated representation of the user query (115) expressed in a formal query language suitable for structured data interpretation. The structured query (125) may be generated by the language model (190) in response to the query construction prompt (122) and may conform to the syntax of SQL, MongoDB query language, Gremlin, Cypher, etc., or a domain-specific query language. The structured query (125) may include clauses specifying entity types, attribute filters, logical conditions, aggregation functions, temporal constraints, spatial filters, etc., derived from the user query (115) and contextual schema information such as the schema definitions (102) and a relationship graph schema for the relationship graph (110). The structured query (125) may be formatted as a text string, an abstract syntax tree, a query object, or another intermediate representation suitable for parsing and transformation. The structured query (125) may reference multiple entities and express inter-entity relationships using logic that is syntactically valid in relational query languages, but which may not be supported by the query execution engine (160). For example, the structured query (125) may use join operations that are not natively supported by the query execution engine (160). The structured query (125) may be deconstructed by the query deconstructor (130) into components such as the source table (131), the target table (133), the query condition (135), and the aggregation operator (137), which are used to generate a traversal path and a sequence of entity-specific queries (162). The structured query (125) functions as an intermediate representation that bridges natural language understanding and executable search logic in schema-based data environments that lack relational capabilities.

The query deconstructor (130) is a processing module configured to analyze the structured query (125) and extract discrete components used for downstream query planning and execution. The query deconstructor (130) may be implemented as a deterministic parser, a rule-based engine, a modular service, etc., and may operate within a query processing engine or as a standalone component. The query deconstructor (130) receives the structured query (125) and identifies structural elements such as the source table (131), the target table (133), the query condition (135), and the aggregation operator (137). The query deconstructor (130) may parse clauses corresponding to selection criteria, filtering logic, grouping instructions, ordering directives, etc., and may normalize the elements into a canonical form. The query deconstructor (130) may support structured query formats that include relational constructs such as joins, subqueries, nested conditions, etc., even if such constructs are not directly executable by the query execution engine (160). The query deconstructor (130) may isolate logical dependencies between entities referenced in the structured query (125) and prepare the extracted components for traversal planning and subquery generation. The query deconstructor (130) may output the extracted components in a format suitable for use by the graph traversal planner (150) and the query execution engine (160). The query deconstructor (130) functions as a transformation layer that bridges structured query representation and executable query logic in schema-based data environments where relational operations are not natively supported.

The source table (131) is a structural element extracted from the structured query (125) that identifies an entity from which records are to be retrieved. The source table (131) may correspond to a table, collection, or entity defined in the schema definitions (102) and referenced in the structured query (125) as the origin of the data retrieval operation. The source table (131) may be identified by the query deconstructor (130) based on parsing of clauses such as FROM, SELECT, MATCH, etc., based on the syntax of the structured query (125). As an example, the source table (131) may represent a well, wellbore, log, marker, trajectory, production record, as well as other domain-specific entities defined in the schema. The source table (131) may be used as the starting point for traversal planning in the graph traversal planner (150) and may influence the direction and scope of the traversal path (155). The source table (131) may be associated with one or more of the target tables (133) through relationships defined in the relationship graph (110) and may participate in application-level joins during query execution. The source table (131) may be used to generate the first entity-specific query (162) in a sequence of subqueries that simulate relational behavior in non-relational data environments. The source table (131) functions as the anchor point for query decomposition and traversal logic in systems that operate on schema-based representations of structured data.

The target table (133) is a structural element extracted from the structured query (125) that identifies an entity on which one or more query conditions are to be applied. The target table (133) may correspond to a table, collection, or entity defined in the schema definitions (102) and referenced in the structured query (125) as a destination for filtering, aggregation, or constraint evaluation. The target table (133) may be identified by the query deconstructor (130) based on parsing of clauses such as WHERE, JOIN, FILTER, etc., based on the syntax of the structured query (125). As an example, the target table (133) may represent a log, marker, trajectory, production record, as well as other domain-specific entities that are related to the source table (131) through one or more edges in the relationship graph (110). The target table (133) may be used to determine the traversal direction and intermediate nodes in the graph traversal planner (150) and may influence the structure of the traversal path (155). The target table (133) may be associated with one or more query conditions (135) and may participate in application-level joins during execution of the entity-specific queries (162). The target table (133) may be used to define the scope of filtering logic and to constrain the result set based on attributes that are not present in the source table (131). The target table (133) functions as a constraint-bearing entity that contributes to the logical structure of the query and the execution plan in schema-based data environments.

The query condition (135) is a logical constraint extracted from the structured query (125) that specifies one or more criteria to be applied during data retrieval. The query condition (135) may be expressed as a comparison, range, pattern, membership, or Boolean expression involving one or more attributes of the target table (133). The query condition (135) may be identified by the query deconstructor (130) through parsing of clauses such as WHERE, FILTER, HAVING, etc., based on the syntax of the structured query (125). The query condition (135) may include operators such as equals, not equals, greater than, less than, between, in, like, and, or, etc., and may be composed of nested or compound expressions. The query condition (135) may reference attributes from the target table (133), the source table (131), or both, based on the structure of the query and the relationships defined in the relationship graph (110). The query condition (135) may be used to constrain the result set returned by the entity-specific queries (162) and may influence the traversal logic computed by the graph traversal planner (150). The query condition (135) may be translated into filter expressions compatible with the query execution engine (160) and may be applied at one or more stages of the application-level join process. The query condition (135) functions as a semantic filter that defines the scope of data retrieval in schema-based systems that support structured query decomposition and traversal.

The aggregation operator (137) is a functional element extracted from the structured query (125) that specifies one or more operations to be applied across sets of values during query processing. The aggregation operator (137) may be identified by the query deconstructor (130) through parsing of clauses such as SELECT, GROUP BY, HAVING, etc., based on the syntax of the structured query (125). The aggregation operator (137) may include functions such as count, sum, average, minimum, maximum, percentile, standard deviation, etc., and may be applied to numeric, categorical, or temporal attributes. The aggregation operator (137) may be associated with attributes from the source table (131), the target table (133), or both, and may be used to compute summary statistics or derived metrics over filtered subsets of records. The aggregation operator (137) may be used to guide the behavior of the language model (190) when generating summarization code or visualization logic in response to the output prompt (172). The aggregation operator (137) may be passed to the query execution engine (160) as part of the traversal logic or may be applied post-retrieval by a summarization module operating on the retrieved records (165). The aggregation operator (137) may be expressed in a structured query language or inferred from natural language expressions in the user query (115), such as “top 5,” “average depth,” “total volume,” etc. The aggregation operator (137) functions as a computational directive that specifies the transformation to be applied to grouped or filtered data for generating summary outputs in schema-based data environments.

The graph traversal planner (150) is a processing module configured to compute a traversal path across the relationship graph (110) based on the source table (131) and the target table (133). The graph traversal planner (150) may be implemented as a hybrid system with a deterministic algorithm and a language model component and may operate as part of a query processing engine or as a standalone service. The graph traversal planner (150) may receive as input the source table (131), the target table (133), and the relationship graph (110), and may compute one or more candidate paths that connect the entities represented by the source table (131) and the target table (133). The graph traversal planner (150) may invoke the shortest path algorithm (151) to identify a minimal-length traversal path based on edge weights, relationship types, or schema-defined constraints. The graph traversal planner (150) may invoke the language model (190) using the action planning prompt (152) to evaluate the semantic validity of the computed path and to refine or reorder traversal steps based on domain-specific reasoning. The graph traversal planner (150) may output the traversal path (155), which defines the sequence of entities and relationships to be followed during query execution. The graph traversal planner (150) may be used to guide the generation of the entity-specific queries (162) and to simulate join behavior in systems that do not support native relational operations. The graph traversal planner (150) functions as a routing mechanism that translates inter-entity relationships into executable traversal logic in schema-based data environments.

The shortest path algorithm (151) is a deterministic algorithm configured to compute one or more minimal-length paths between the source table (131) and the target table (133) within the relationship graph (110). The shortest path algorithm (151) may be implemented using graph traversal techniques such as Dijkstra's algorithm, Bellman-Ford algorithm, A* search, breadth-first search, etc., and may operate on directed or undirected graphs. The shortest path algorithm (151) may evaluate edge weights, relationship types, or schema-defined constraints to determine traversal cost and to identify optimal paths. The shortest path algorithm (151) may be invoked by the graph traversal planner (150) to generate candidate paths that connect the entities represented by the source table (131) and the target table (133). The shortest path algorithm (151) may output one or more paths that minimize the number of traversal steps, the cumulative edge weight, or other cost metrics defined by the schema or application logic. The shortest path algorithm (151) may operate independently or in conjunction with the language model (190), which may further refine or validate the computed paths based on domain-specific reasoning. The shortest path algorithm (151) functions as a pathfinding mechanism that identifies efficient traversal sequences across inter-entity relationships in schema-based data environments.

The action planning prompt (152) is a prompt input configured to instruct the language model (190) to generate the traversal path (155) based on the output of the shortest path algorithm (151) and the schema-level context. The action planning prompt (152) may be implemented as a structured instruction, a dynamic prompt string, a serialized object, etc., and may include references to the source table (131), the target table (133), the relationship graph (110), and the candidate paths computed by the shortest path algorithm (151). The action planning prompt (152) may include schema metadata, relationship types, edge annotations, and domain-specific constraints to guide the reasoning process of the language model (190). The action planning prompt (152) may be formatted to elicit a structured output that defines the traversal path (155) as a sequence of entities and relationships to be followed during query execution. The action planning prompt (152) may be used to validate, refine, or reorder the candidate paths based on semantic correctness, domain conventions, or optimization criteria not captured by the shortest path algorithm (151). The action planning prompt (152) may be generated dynamically based on the complexity of the query, the number of intermediate entities, or the ambiguity of the relationship graph (110). The action planning prompt (152) functions as a reasoning interface that translates graph-based connectivity into traversal logic suitable for application-level query execution in schema-based data environments.

The traversal path (155) is a structured output generated by the language model (190) in response to the action planning prompt (152) and represents a sequence of entities and relationships to be followed during query execution. The traversal path (155) may be derived from one or more candidate paths computed by the shortest path algorithm (151) and refined based on schema-level context, domain-specific constraints, or semantic reasoning. The traversal path (155) may be represented as an ordered list, a graph walk, a serialized object, or another format suitable for use by the query execution engine (160). The traversal path (155) may include intermediate entities, relationship types, edge directions, and traversal metadata that define the logical flow from the source table (131) to the target table (133). The traversal path (155) may be used to guide the generation of the entity-specific queries (162) and to determine the order in which subqueries are executed and results are joined at the application level. The traversal path (155) may reflect optimization criteria such as minimal traversal depth, reduced data volume, or alignment with domain-specific access patterns. The traversal path (155) functions as an execution blueprint that translates schema-level relationships into a concrete sequence of retrieval operations in schema-based data environments.

The query execution engine (160) is a processing module configured to execute a sequence of entity-specific queries (162) based on the traversal path (155) and the extracted components of the structured query (125). The query execution engine (160) may be implemented as a software service, a distributed query processor, a containerized function, etc., and may operate in conjunction with a non-relational search engine. The query execution engine (160) may receive as input the traversal path (155), the source table (131), the target table (133), the query condition (135), and the aggregation operator (137). The query execution engine (160) may generate and execute the entity-specific queries (162) in an order defined by the traversal path (155), and may perform intermediate filtering, mapping, and record matching operations. The query execution engine (160) may simulate join behavior by executing multiple queries across related entities and aggregating the results at the application level. The query execution engine (160) may translate structured query logic into search-compatible formats such as Lucene query syntax, Elasticsearch DSL, or other non-relational query languages. The query execution engine (160) may output the retrieved records (165), which represent the result of executing the entity-specific queries (162) across the schema-defined entities. The query execution engine (160) functions as a runtime component that transforms traversal logic and query decomposition into executable operations in schema-based data environments that do not support native relational joins.

The entity-specific queries (162) are a sequence of discrete queries generated by the query execution engine (160) based on the traversal path (155) and the extracted components of the structured query (125). The entity-specific queries (162) may be constructed to operate on individual entities such as the source table (131), the target table (133), or intermediate entities identified in the traversal path (155). The entity-specific queries (162) may be expressed in a search-compatible format such as Lucene query syntax, Elasticsearch DSL, or another non-relational query language. The entity-specific queries (162) may incorporate the query condition (135) and may apply filtering logic, attribute selection, and pagination directives specific to each entity. The entity-specific queries (162) may be executed in a defined order that reflects the traversal path (155), with intermediate results passed between queries to simulate join behavior. The entity-specific queries (162) may be generated dynamically at runtime and may vary in structure based on the schema relationships, query complexity, data dependencies, etc. The entity-specific queries (162) function as modular retrieval operations that collectively implement the logical intent of the structured query (125) in schema-based data environments that do not support native relational joins.

The retrieved records (165) are the result set produced by executing the entity-specific queries (162) in accordance with the traversal path (155) and the extracted components of the structured query (125). The retrieved records (165) may include data from the source table (131), the target table (133), or intermediate entities, and may reflect the application of the query condition (135) and the aggregation operator (137). The retrieved records (165) may be represented as structured documents, tabular rows, JSON objects, or other formats compatible with downstream summarization or visualization components. The retrieved records (165) may be generated through sequential execution of the entity-specific queries (162), with intermediate results passed between queries to simulate join behavior in non-relational environments. The retrieved records (165) may include metadata such as entity identifiers, relationship keys, timestamps, and attribute values used for filtering, grouping, or aggregation. The retrieved records (165) may be passed to the output generator (170) for summarization, or visualization, and further processing, and presentation to the user. The retrieved records (165) function as the final output of the query execution engine (160) and represent the structured data retrieved in response to the user query (115) in schema-based data environments.

The output generator (170) is a processing module configured to generate a response based on the retrieved records (165) and the extracted components of the structured query (125). The output generator (170) may be implemented as a modular service, a prompt orchestration layer, a response formatting engine, etc., and may operate within a query processing engine or as a standalone component. The output generator (170) may receive, as input, the retrieved records (165), the aggregation operator (137), and the user query (115). The output generator (170) may construct one or more prompts for downstream processing. The output generator (170) may invoke the output prompt (172), which may include the summarization prompt (175) and the visualization prompt (178), to instruct the language model (190) to generate a textual summary or visualization code. The output generator (170) may format the retrieved records (165) into a structure suitable for summarization, such as a tabular array, a grouped dataset, or a filtered subset. The output generator (170) may apply the aggregation operator (137) to the retrieved records (165) either directly or by passing the aggregation operator (137) as an instruction to the language model (190). The output generator (170) may produce a response that includes a textual summary, a chart specification, a code snippet, or another structured output suitable for presentation to the user. The output generator (170) functions as a response synthesis layer that transforms structured data into human-readable or machine-renderable outputs in schema-based data environments.

The output prompt (172) is a prompt input configured to instruct the language model (190) to generate a response based on the retrieved records (165) and the extracted components of the structured query (125). The output prompt (172) may be implemented as a structured instruction, a dynamic prompt string, a serialized object, etc., and may include one or more subprompts, such as the summarization prompt (175) and the visualization prompt (178). The output prompt (172) may include contextual inputs such as the user query (115), the aggregation operator (137), and a formatted representation of the retrieved records (165). The output prompt (172) may be constructed to elicit a specific type of output, such as a textual summary, a chart specification, a code snippet, or a structured explanation. The output prompt (172) may be generated dynamically based on the nature of the user query (115), the structure of the retrieved records (165), or the presence of aggregation or visualization specifications. The output prompt (172) may be used to guide the language model (190) in producing a response that is syntactically valid, semantically relevant, and aligned with the informational intent of the user query (115). The output prompt (172) may be implemented as one or more of the summarization prompt (175) and the visualization prompt (178). The output prompt (172) functions as a response-generation interface that translates structured data and query context into natural language or code-based outputs in schema-based data environments.

The summarization prompt (175) is a prompt input configured to instruct the language model (190) to generate a textual summary based on the retrieved records (165) and the contextual elements of the structured query (125). The summarization prompt (175) may be implemented as a structured instruction, a dynamic prompt string, a serialized object, etc., and may include references to the user query (115), the aggregation operator (137), and a formatted representation of the retrieved records (165). The summarization prompt (175) may be constructed to elicit a response that includes statistical summaries, grouped values, ranked results, descriptive insights, or other forms of natural language output. The summarization prompt (175) may be generated dynamically based on the structure, volume, and content of the retrieved records (165), and may reflect the presence of aggregation, filtering, or grouping logic. The summarization prompt (175) may be used to guide the language model (190) in producing a response that is concise, contextually relevant, and aligned with the informational intent of the user query (115). The summarization prompt (175) may be used independently or in conjunction with the visualization prompt (178), based on the nature of the output requested. The summarization prompt (175) functions as a natural language generation interface that transforms structured data into human-readable summaries in schema-based data environments.

The visualization prompt (178) is a prompt input configured to instruct the language model (190) to generate visualization code based on the retrieved records (165) and the contextual elements of the structured query (125). The visualization prompt (178) may be implemented as a structured instruction, a dynamic prompt string, a serialized object, etc., and may include references to the user query (115), the aggregation operator (137), and a formatted representation of the retrieved records (165). The visualization prompt (178) may be constructed to elicit a response that includes chart specifications, plotting instructions, rendering parameters, or other forms of code-based visual output. The visualization prompt (178) may be generated dynamically based on the structure, type, and dimensionality of the retrieved records (165), and may reflect the presence of temporal, spatial, categorical, or numerical attributes. The visualization prompt (178) may be used to guide the language model (190) in producing a response that includes executable code for generating plots such as bar charts, line graphs, scatter plots, histograms, etc. The visualization prompt (178) may be used independently or in conjunction with the summarization prompt (175), based on the nature of the output requested. The visualization prompt (178) functions as a code generation interface that transforms structured data into visual representations in schema-based data environments.

The textual summary (185) is a natural language output generated by the language model (190) in response to the summarization prompt (175) and based on the retrieved records (165). The textual summary (185) may be presented as a paragraph, a list, a table, or another structured format that conveys the results of the query in a human-readable form. The textual summary (185) may include statistical values, grouped results, ranked entries, descriptive insights, or other forms of synthesized information derived from the retrieved records (165). The textual summary (185) may reflect the application of the aggregation operator (137) and may describe patterns, distributions, or anomalies present in the structured data. The textual summary (185) may be formatted to align with the informational intent of the user query (115) and may incorporate terminology or phrasing consistent with the domain of the underlying schema. The textual summary (185) may be generated independently or in conjunction with the visualization code (188), based on the structure of the output prompt (172). The textual summary (185) functions as a human-interpretable representation of structured data retrieved and processed in schema-based data environments.

The visualization code (188) is a code-based output generated by the language model (190) in response to the visualization prompt (178) and based on the retrieved records (165). The visualization code (188) may be expressed in a programming language such as Python, JavaScript, R, etc., and may use libraries such as Matplotlib, Plotly, Vega-Lite, D3.js, etc., to define visual elements. The visualization code (188) may include instructions for rendering charts such as bar charts, line graphs, scatter plots, histograms, pie charts, etc., based on the structure and content of the retrieved records (165). The visualization code (188) may specify chart parameters such as axis labels, titles, legends, color schemes, data mappings, and layout configurations. The visualization code (188) may be generated dynamically based on the dimensionality, data types, and aggregation logic present in the retrieved records (165). The visualization code (188) may be executed by a rendering engine or visualization component to produce a graphical representation of the structured data. The visualization code (188) functions as a machine-readable specification that transforms structured data into visual output in schema-based data environments.

The language model (190) is a machine learning model configured to perform multiple prompt-based tasks within a schema-based data environment. The language model (190) may be implemented using transformer-based architectures, may be a large language model (LLM), such as GPT-4, Claude, LLaMA, Mistral, etc., and may be deployed as a hosted service, containerized module, or integrated component of a computing system. The language model (190) receives prompt inputs that include structured instructions, schema definitions, relationship graphs, user queries, and retrieved records. The language model (190) processes each prompt to generate outputs such as structured queries, traversal paths, textual summaries, and visualization code. The language model (190) operates in multiple roles including query constructor, action planner, summarizer, and visualization generator. The language model (190), when acting as a query constructor, receives a query construction prompt and generates a structured query based on the user query and schema context. The language model (190), when acting as an action planner, receives an action planning prompt and generates a traversal path based on a relationship graph and shortest path algorithm. The language model (190), when acting as a summarizer, receives a summarization prompt and generates a textual summary based on retrieved records and aggregation operators. The language model (190), when acting as a visualization generator, receives a visualization prompt and generates visualization code based on the structure and content of the retrieved records. The language model (190) processes text-based inputs and produces text-based outputs, including structured query language, natural language summaries, and executable code. The language model (190) functions as a prompt-executing engine that transforms user intent and structured data into machine-readable and human-readable outputs in schema-based data environments.

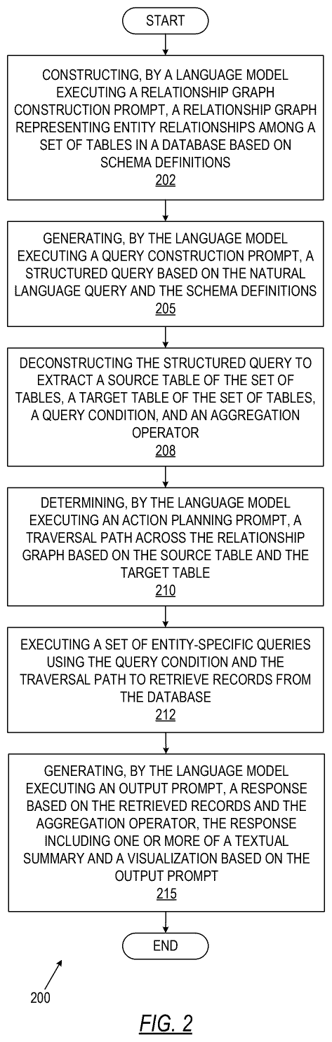

FIG. 2 shows a flowchart of a method for language model powered search on structured records using relationship graphs. The method of FIG. 2 may be implemented using the systems described in the other figures, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 2, the method (200) retrieves and processes structured data in response to a natural language query. The process (200) may include multiple steps (e.g., Block 202 through Block 215) that may execute on the components described in the other figures, including those of FIG. 1, FIG. 9.1, and FIG. 9.2.

Block 202 involves constructing, by a language model executing a relationship graph construction prompt, a relationship graph representing entity relationships among a set of tables in a database based on schema definitions. To construct a relationship graph, a computer system retrieves schema definitions that describe the structure, attributes, and interdependencies of entities stored in the database. The schema definitions may include metadata such as entity names, field names, data types, parent-child relationships, and foreign key references. The system constructs a prompt, referred to as a relationship graph construction prompt, which includes the schema definitions as input and is formatted to instruct a language model to analyze the schema content. The language model processes the relationship graph construction prompt to interpret the schema definitions and identify logical connections of the entities, including direct and indirect relationships, containment hierarchies, and referential constraints. Based on the analysis, the language model generates a structured representation of the relationships among the entities, which is output as a relationship graph. The relationship graph includes nodes representing individual entities and edges representing the relationships between the nodes, such as one-to-many or many-to-one associations. The relationship graph may be implemented using a graph data structure such as an adjacency list or edge list and may be stored in memory or persisted in a graph database for later use.

Block 205 involves generating, by the language model executing a query construction prompt, a structured query based on the natural language query and the schema definitions. To generate the structured query, a computer system receives a natural language query that expresses an intent of a user to retrieve information from a structured data source. The natural language query may include references to entities, attributes, conditions, or aggregation instructions that correspond to elements defined in the schema. The system retrieves schema definitions that describe the structure and semantics of the entities in the database, including field names, data types, and inter-entity relationships. The system constructs a query construction prompt that includes the natural language query and the schema definitions as input. The query construction prompt is formatted to instruct a language model to interpret the natural language query in the context of the schema definitions. The language model processes the query construction prompt to identify the entities referenced in the query, the attributes involved in filtering or selection, and any logical or aggregation conditions. The language model maps the identified elements to corresponding schema-defined entities and attributes and generates a structured query that conforms to a formal query language such as SQL or a domain-specific equivalent. The structured query includes clauses that specify the source entities, filtering conditions, and any aggregation or grouping operations used to fulfill the intent of the natural language query. The structured query is output in a machine-readable format and is passed to subsequent components for deconstruction, traversal planning, and execution.

Block 208 involves deconstructing the structured query to extract a source table of the set of tables, a target table of the set of tables, a query condition, and an aggregation operator. To deconstruct the structured query, a computer system receives the structured query generated by the language model in response to the query construction prompt. The structured query is parsed to identify a primary entity from which data is to be retrieved, which is designated as the source table. The structured query is further analyzed to identify one or more entities on which filtering or constraint conditions are applied, which are designated as target tables. The system examines the conditional clauses of the structured query, such as WHERE or FILTER clauses, to extract the query condition. The query condition specifies logical constraints that are to be satisfied by the data, such as comparisons, ranges, or pattern matches involving one or more attributes. The system also identifies any aggregation operator present in the structured query, such as functions that compute count, sum, average, minimum, maximum, or other statistical measures over sets of values. The aggregation operator may be explicitly defined in clauses such as SELECT or GROUP BY or may be inferred from the structure of the query. The extracted source table, target table, query condition, and aggregation operator are output as discrete components for use in subsequent graph traversal and query execution steps. The components are used to guide the construction of traversal paths, the generation of subqueries, and the formulation of search logic in systems that do not support native relational joins.

Block 210 involves determining, by the language model executing an action planning prompt, a traversal path across the relationship graph based on the source table and the target table. To determine the traversal path, a computer system receives the source table and the target table extracted from the structured query. The system accesses a relationship graph that represents the interconnections among entities in the database, where nodes correspond to entities and edges represent relationships such as parent-child associations or foreign key references. The system executes a shortest path algorithm to the relationship graph to compute one or more candidate paths that connect the source table to the target table. The shortest path algorithm may be Dijkstra's algorithm, Bellman-Ford algorithm, or another graph traversal algorithm that identifies paths based on edge weights, relationship types, or schema-defined constraints. The system constructs an action planning prompt that includes the source table, the target table, the relationship graph, and the candidate paths computed by the shortest path algorithm. The action planning prompt is formatted to instruct a language model to evaluate the candidate paths and generate a traversal path that is semantically valid and consistent with domain-specific constraints. The language model processes the action planning prompt to reason over the structure of the relationship graph and the logical flow of data between entities. The language model outputs a traversal path that specifies the sequence of entities and the relationships to be followed to move from the source table to the target table. The traversal path may include intermediate entities, edge directions, and relationship types and is used to guide the generation of subqueries and the formulation of application-level joins in subsequent steps.

Block 212 involves executing a set of entity-specific queries using the query condition and the traversal path to retrieve records from the database. To execute the entity-specific queries, a computer system receives the traversal path generated by the language model and the query condition extracted from the structured query. The traversal path specifies a sequence of entities and relationships that define navigation from the source table to the target table through one or more intermediate entities. The system generates a first query directed to the source table, applying any applicable portion of the query condition that corresponds to attributes of the source table. The system executes the first query using a search engine that supports document-level retrieval, such as a Lucene-based engine, and obtains a set of matching records. The system extracts identifiers or foreign key values from the matching records and uses the values to formulate a second query directed to the next entity in the traversal path. The second query is constructed to retrieve records from the next entity that are related to the previously retrieved records based on the relationship defined in the relationship graph. The process may be repeated for each entity in the traversal path, with each subsequent query incorporating identifiers or constraints derived from the results of the preceding query. The system applies the query condition to each entity-specific query as appropriate, based on the attributes and filtering logic defined in the structured query. The system aggregates the results of the entity-specific queries to produce a unified set of retrieved records that satisfy the query condition across the traversal path. The retrieved records are output in a structured format and passed to downstream components for summarization, visualization, or further processing.

Block 215 involves generating, by the language model executing an output prompt, a response based on the retrieved records and the aggregation operator, the response including one or more of a textual summary and a visualization based on the output prompt. To generate the response, a computer system receives the retrieved records produced by executing the entity-specific queries and the aggregation operator extracted from the structured query. The system constructs an output prompt that includes the retrieved records, the aggregation operator, and optionally the original natural language query. The output prompt is formatted to instruct a language model to generate a response that reflects the informational intent of the query and the structure of the retrieved data. The language model processes the output prompt to determine whether the response should include a textual summary, a visualization, or both. If the response includes a textual summary, the system constructs a summarization prompt that instructs the language model to describe the contents of the retrieved records using natural language. The summarization prompt may include instructions to apply the aggregation operator to the retrieved records, such as computing statistical measures, grouping values, or identifying patterns. The language model generates a textual summary that may include narrative descriptions, tabular representations, or enumerated results derived from the retrieved records. If the response includes a visualization, the system constructs a visualization prompt that instructs the language model to generate code for rendering a chart or graph based on the retrieved records. The visualization prompt may specify the type of chart, the data fields to be plotted, and the formatting parameters such as axis labels, color schemes, or legends. The language model generates visualization code that may be executed by a rendering engine to produce a graphical representation of the data. The textual summary and the visualization code are output as components of the response and may be presented to the user through a user interface or passed to downstream systems for further processing.

The method (200) may further involve embedding the schema definitions and relationship graph in a vector database prior to constructing the relationship graph. To perform the embedding, a computer system retrieves schema definitions that describe the structure, attributes, and metadata of entities in the database. The schema definitions may include entity names, field names, data types, descriptions, and inter-entity references. The system also retrieves a relationship graph that represents the logical connections among the entities, including parent-child relationships, foreign key associations, and containment hierarchies. The system processes the schema definitions and the relationship graph to generate vector embeddings using a language model or embedding model trained to produce semantically meaningful representations of structured text. Each schema definition and each segment of the relationship graph is converted into a high-dimensional vector that captures the semantic content of the input. The system stores the resulting vector embeddings in a vector database that supports similarity-based retrieval using distance metrics such as cosine similarity or dot product. The vector database is indexed to allow efficient retrieval of schema fragments and relationship segments that are most relevant to a given input query. The embedded representations are used in subsequent steps to support retrieval-augmented generation, where relevant schema content is dynamically retrieved and incorporated into prompts provided to the language model. The embedding of the schema definitions and the relationship graph in the vector database enables scalable and context-aware query construction in environments with large or complex schemas.

The method (200) may further involve retrieving a subset of relevant schema definitions from a vector database using a retriever module prior to generating the structured query. To retrieve the relevant schema definitions, a computer system receives a natural language query that expresses an intent to access structured data. The system generates a vector embedding of the natural language query using an embedding model trained to produce semantically meaningful representations of text. The system queries a vector database that contains precomputed embeddings of schema definitions and relationship graph segments. The vector database performs a similarity search by comparing the query embedding to the stored embeddings using a distance metric such as cosine similarity or dot product. The vector database returns a ranked list of schema definitions and relationship segments that are most semantically similar to the natural language query. The system selects a subset of the top-ranked schema definitions based on a relevance threshold or a fixed number of results. The selected schema definitions are retrieved in an original text form and are used as contextual input for constructing a query construction prompt. The retrieved schema definitions may be incorporated into the prompt provided to the language model to guide the generation of a structured query that is aligned with the relevant portions of the schema. The retrieval of a subset of schema definitions from the vector database enables the system to operate efficiently in environments where the full schema exceeds the input capacity of the language model.

The method (200) may further involve identifying, by the language model, a conversational context from prior user queries and incorporating the conversational context into the structured query. To identify the conversational context, a computer system maintains a record of prior user queries and corresponding system responses within a session. Each prior query and response are stored as a text segment that captures the evolving intent and informational requests expressed during the interaction. The system constructs a prompt that includes the current natural language query along with one or more prior queries and responses as contextual input. The prompt is formatted to instruct a language model to interpret the current query in light of the preceding conversational history. The language model processes the prompt to identify references to previously mentioned entities, attributes, conditions, or results. The language model resolves anaphoric expressions, implicit references, and follow-up instructions by linking to relevant elements in the prior queries or responses. The language model incorporates the resolved context into the generation of a structured query that reflects both the current query and the accumulated conversational history. The structured query may include additional filtering conditions, entity references, or aggregation logic that are inferred from the prior context. The incorporation of conversational context enables the system to support multi-turn interactions and generate structured queries that are coherent across sequential user inputs.

The method (200) may further involve validating the traversal path by the language model based on domain-specific constraints derived from the schema definitions. To validate the traversal path, a computer system receives a candidate path generated by a shortest path algorithm that connects a source table to a target table through one or more intermediate entities. The system retrieves schema definitions that describe the structure, semantics, and constraints of the entities and relationships represented in the traversal path. The system constructs an action planning prompt that includes the candidate traversal path and the relevant schema definitions. The prompt is formatted to instruct a language model to evaluate the semantic correctness of the traversal path in the context of the domain-specific constraints. The language model processes the prompt to identify whether the sequence of entities and relationships in the traversal path conforms to the logical and referential rules defined in the schema. The language model may detect violations such as invalid relationship directions, missing foreign key references, or illogical entity transitions. The language model outputs a validated traversal path that satisfies the domain-specific constraints and is suitable for use in generating entity-specific queries. The validated traversal path is used in subsequent steps to guide the formulation of search logic and the execution of application-level joins across related entities.

The method (200) may further involve generating, by the language model, a sequence of subqueries corresponding to the set of entity-specific queries. To generate the subqueries, a computer system receives a validated traversal path that specifies a sequence of entities and relationships connecting a source table to a target table. The system also receives a query condition that defines filtering logic and an aggregation operator that specifies a data transformation to be applied to the results. The system constructs a prompt that includes the traversal path, the query condition, and the aggregation operator. The prompt is formatted to instruct a language model to generate a sequence of subqueries that correspond to the entities and relationships defined in the traversal path. The language model processes the prompt to identify the appropriate query logic for each entity in the traversal path, including the application of filters, the extraction of identifiers, and the propagation of constraints across related entities. The language model outputs a sequence of subqueries, each of which is directed to a specific entity and includes conditions or keys derived from the results of preceding subqueries. The subqueries are expressed in a format compatible with the underlying search engine, such as Lucene query syntax or another non-relational query language. The sequence of subqueries is used to simulate join operations at the application level by retrieving and linking records across multiple entities in accordance with the traversal path. The generation of subqueries by the language model enables the system to execute complex multi-entity queries in environments that do not support native relational joins.

The method (200) may further involve transforming the structured query into a format compatible with a non-relational search engine. To perform the transformation, a computer system receives a structured query that includes clauses specifying source entities, filtering conditions, and aggregation logic. The structured query may be expressed in a relational query language such as SQL or in a domain-specific format that assumes support for join operations. The system parses the structured query to identify the logical components, including entity references, attribute filters, relational dependencies, etc. The system constructs a prompt that includes the parsed components and the capabilities of the target search engine, such as Lucene or Elasticsearch. The prompt is formatted to instruct a language model to translate the structured query into a set of search-compatible expressions that simulate the intended logic. The language model processes the prompt to generate a transformed query that uses the syntax and semantics of the non-relational search engine. The transformed query may include Boolean expressions, range filters, keyword matches, and nested queries that operate on document-level fields. The transformed query omits unsupported constructs such as native joins and instead relies on application-level logic to coordinate multi-entity retrieval. The transformed query is output in a machine-readable format and is used to execute entity-specific searches that collectively fulfill the intent of the original structured query.

The method (200) may further involve generating, by the language model, executable code that performs a data transformation operation on the retrieved records, the data transformation operation including one or more of filtering, grouping, aggregating, and smoothing. To generate the executable code, a computer system receives a set of retrieved records produced by executing entity-specific queries and a data transformation instruction derived from the structured query or the natural language query. The system constructs a prompt that includes the retrieved records, the transformation instruction, and optionally the aggregation operator. The prompt is formatted to instruct a language model to generate code that performs the specified transformation on the retrieved records. The language model processes the prompt to identify the appropriate transformation logic, such as applying filters to select subsets of records, grouping records by one or more attributes, computing aggregate values such as sums or averages, applying smoothing techniques such as moving averages, etc. The language model generates executable code in a programming language such as Python, which may use libraries or functions for data manipulation and analysis. The generated code is structured to operate on the retrieved records and produce a transformed output that reflects the specified data operation. The executable code is output in a machine-readable format and may be executed by a runtime environment to produce a result that is used in a textual summary, a visualization, a downstream computation, etc. The generation of executable code by the language model enables dynamic and context-aware data processing without specifying predefined transformation templates.

The method (200) may further involve generating, by the language model, a viewer selection instruction based on a type of table from which the retrieved records originated. To generate the viewer selection instruction, a computer system receives a set of retrieved records that have been obtained through execution of entity-specific queries. The system identifies the table or entity type associated with the retrieved records by examining metadata, schema references, or query lineage. The system constructs a prompt that includes the retrieved records and the associated table type. The prompt is formatted to instruct a language model to determine an appropriate viewer or visualization component for presenting the retrieved records. The language model processes the prompt to evaluate the structure and semantics of the data and to associate the table type with a corresponding viewer. The viewer may be selected based on predefined mappings between entity types and viewer types, such as mapping well log tables to log viewers, spatial entities to map viewers, tabular data to grid viewers, etc. The language model outputs a viewer selection instruction that specifies the viewer type to be invoked for rendering the retrieved records. The viewer selection instruction is passed to a user interface component or rendering engine that loads the appropriate viewer and displays the data accordingly. The generation of viewer selection instructions by the language model enables dynamic and context-sensitive presentation of structured data based on the originating table type.

The method (200) may further involve presenting a plot of the retrieved records, in which the plot is generated from visualization code produced by the language model executing a visualization prompt included in the output prompt. To present the plot, a computer system receives visualization code generated by a language model in response to a visualization prompt. The visualization prompt is constructed using the retrieved records, the original natural language query, and any applicable aggregation or transformation instructions. The visualization prompt is formatted to instruct the language model to generate code that renders a graphical representation of the retrieved records. The language model processes the prompt to determine the appropriate chart type, data mappings, and rendering parameters based on the structure and semantics of the data. The language model outputs visualization code in a programming language such as Python or JavaScript, which may use libraries such as Matplotlib, Plotly, Vega-Lite, D3.js, etc. The system executes the visualization code in a runtime environment to generate a plot that visually represents the retrieved records. The plot may include axes, labels, legends, color encodings, and other graphical elements that convey the structure and meaning of the data. The system presents the plot in a user interface component that supports interactive or static rendering, based on the capabilities of the viewer. The presentation of the plot enables visual interpretation of the retrieved records and supports downstream analysis, decision-making, or user interaction.

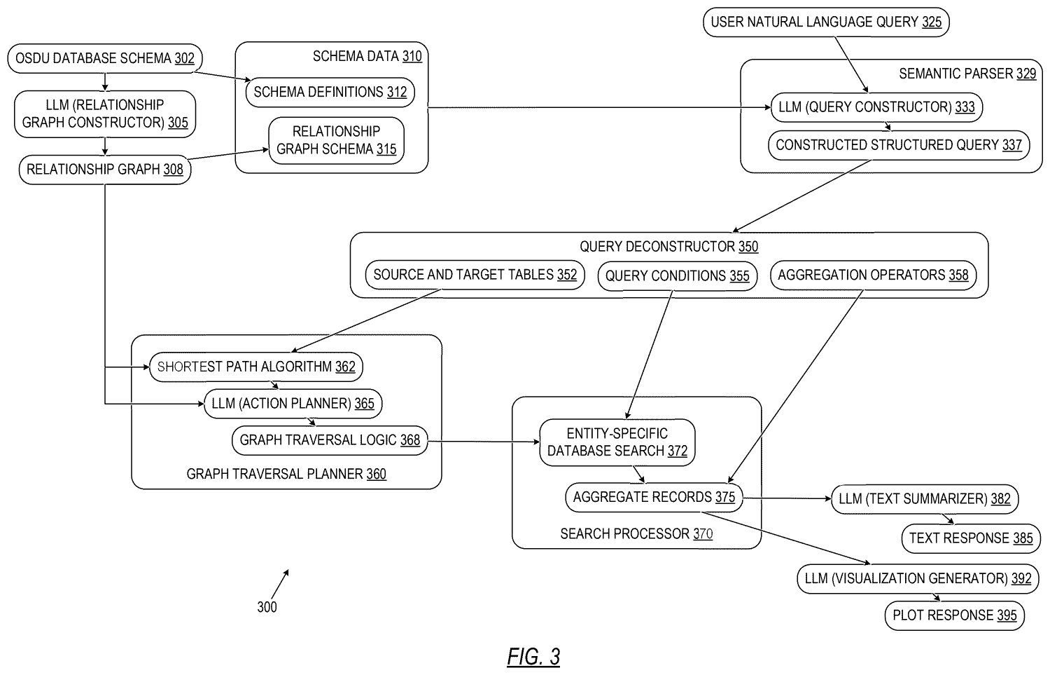

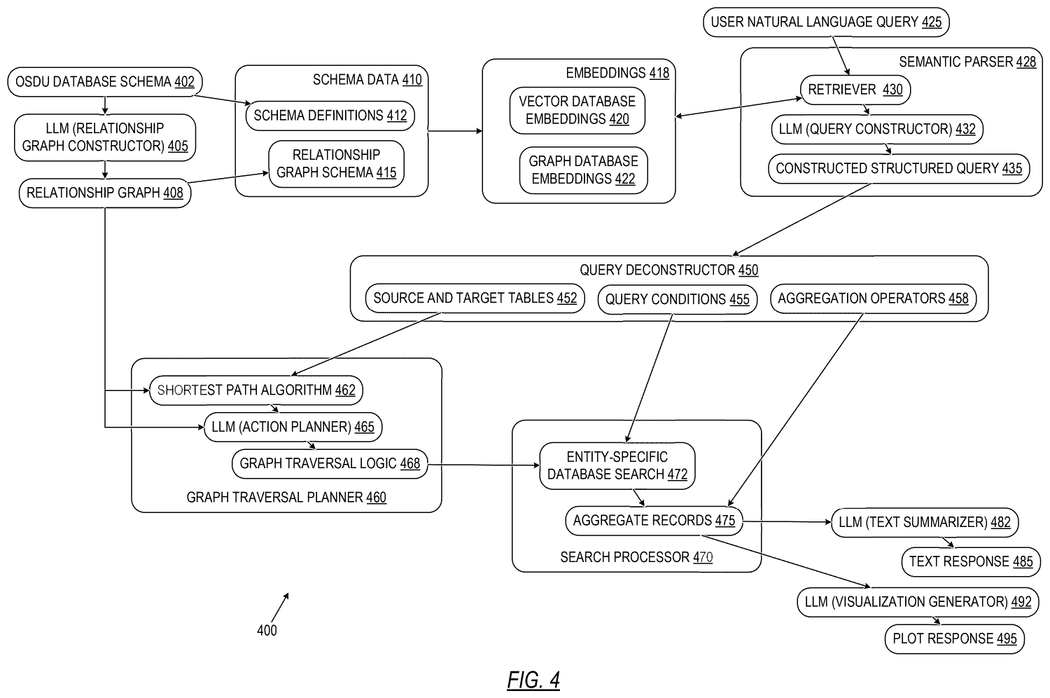

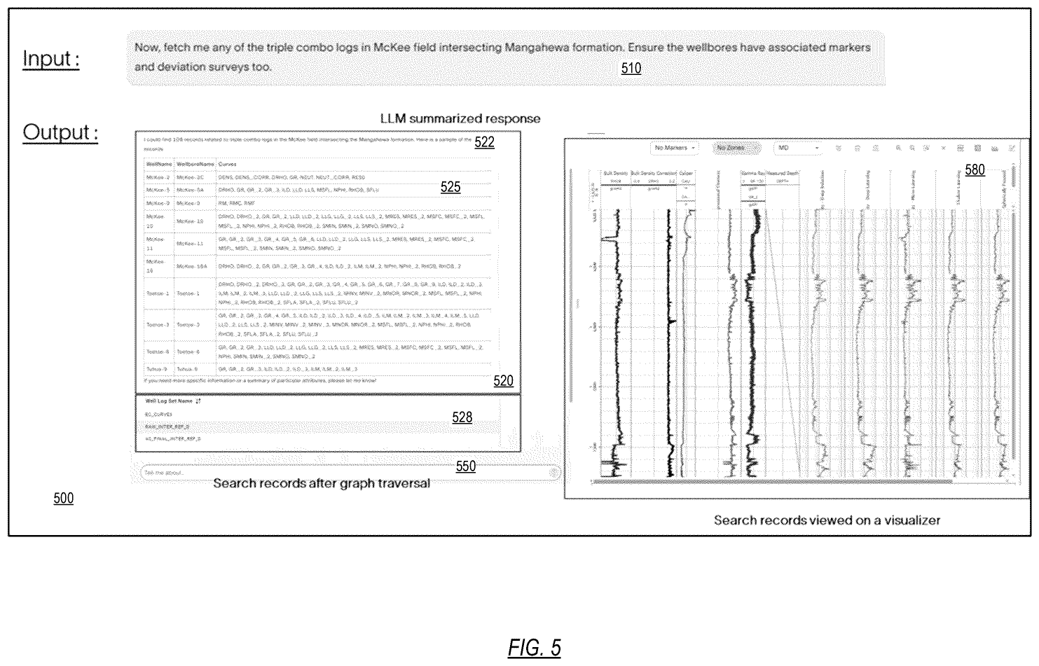

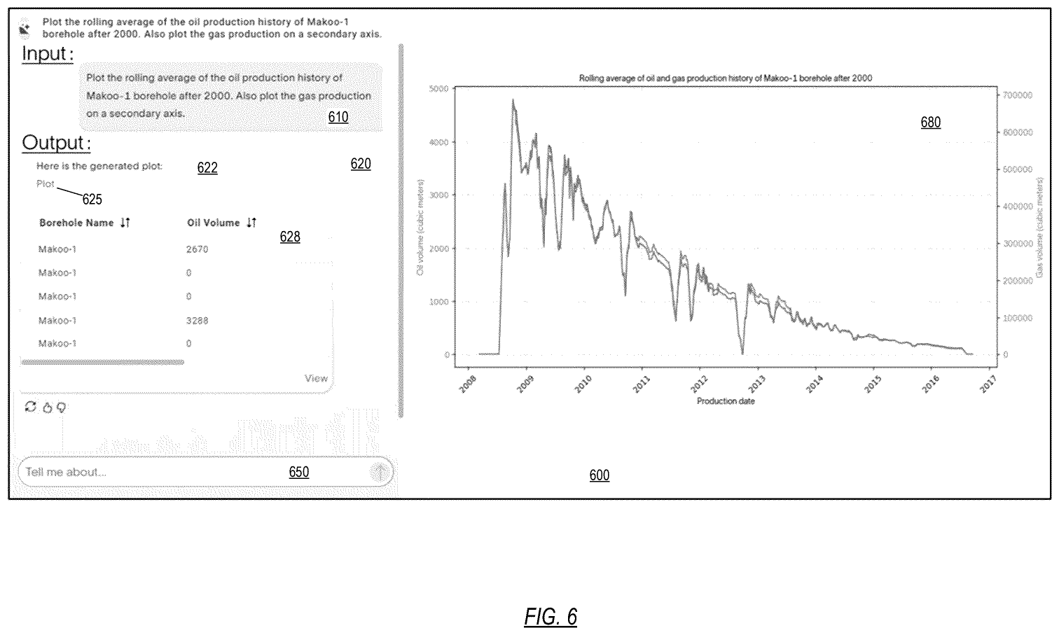

Turning to FIG. 3, the components (300) illustrate an embodiment of a system for processing a user natural language query using a language model (e.g., a large language model (LLM)) to retrieve and summarize structured data from a schema-based data environment. The OSDU database schema (302) provides the foundational schema definitions and entity relationships used throughout the system. The language model operating as the relationship graph constructor (305) receives the OSDU database schema (302) and generates the relationship graph (308). The relationship graph (308) is a structured representation of inter-entity relationships and is used to derive the relationship graph schema (315). The schema definitions (312) and the relationship graph schema (315) are grouped within the schema data (310) and are used as contextual inputs for downstream processing.

The user natural language query (325) is received and passed to the semantic parser (329). Within the semantic parser (329), the language model acting as the query constructor (333) interprets the user natural language query (325) in light of the schema definitions (312) and the relationship graph schema (315) to generate the constructed structured query (337). The constructed structured query (337) is a formal representation of the user's intent and is passed to the query deconstructor (350).

The query deconstructor (350) parses the constructed structured query (337) to extract the source and target tables (352), the query conditions (355), and the aggregation operators (358). The source and target tables (352) are used to identify the entities involved in the query, the query conditions (355) define the logical constraints to be applied, and the aggregation operators (358) specify the data transformation operations to be performed on the retrieved records.

The graph traversal planner (360) receives the source and target tables (352) and uses the shortest path algorithm (362) to compute candidate paths through the relationship graph (308). The language model acting as the action planner (365) evaluates the output of the shortest path algorithm (362) and generates the graph traversal logic (368). The graph traversal logic (368) defines the sequence of entities and relationships to be followed during query execution and is passed to the search processor (370).

The search processor (370) uses the graph traversal logic (368) and the query conditions (355) to perform an entity-specific database search (372). The entity-specific database search (372) retrieves records from the relevant entities and produces the aggregate records (375). The aggregate records (375) represent the result set obtained by executing the query logic across the schema-defined entities.

The aggregate records (375) are passed to the language model acting as the text summarizer (382) and the language model acting as the visualization generator (392). The language model acting as the text summarizer (382) processes the aggregate records (375) and the aggregation operators (358) to generate the text response (385). The language model acting as the visualization generator (392) processes the same inputs to generate the plot response (395). The text response (385) provides a human-readable summary of the retrieved data, and the plot response (395) provides a visual representation of the data in accordance with the user's query.

Turning to FIG. 4, the components (400) illustrate an embodiment of a system for processing a user natural language query using a language model in conjunction with retrieval-augmented generation (RAG) to retrieve and visualize structured data from a schema-based data environment. The components (400) differ from the components (300) of FIG. 3 by incorporating additional modules for embedding and retrieval to support large-scale schema contexts that exceed the input capacity of the language model.

The OSDU database schema (402) provides the foundational schema definitions and entity relationships used throughout the system. The language model operating as the relationship graph constructor (405) receives the OSDU database schema (402) and generates the relationship graph (408). The relationship graph (408) is a structured representation of inter-entity relationships and is used to derive the relationship graph schema (415). The schema definitions (412) and the relationship graph schema (415) are grouped within the schema data (410) and are used as contextual inputs for downstream processing.

The embeddings (418) include the vector database embeddings (420) and the graph database embeddings (422). The vector database embeddings (420) store high-dimensional vector representations of schema definitions, and the graph database embeddings (422) store vector representations of the relationship graph schema (415). The embeddings (418) are generated from the schema data (410) and are used to support semantic retrieval of relevant schema fragments.

The user natural language query (425) is received and passed to the semantic parser (428). The semantic parser (428) includes the retriever (430), which is not present in FIG. 3. The retriever (430) uses the embeddings (418) to identify the most relevant schema definitions and relationship graph segments based on the user natural language query (425). The retriever (430) outputs a subset of schema definitions that are semantically similar to the user natural language query (425) and supplies the selected schema definitions as input to the language model acting as the query constructor (432). The query constructor (432) generates the constructed structured query (435) based on the retrieved schema context.

The query deconstructor (450) parses the constructed structured query (435) to extract the source and target tables (452), the query conditions (455), and the aggregation operators (458). The source and target tables (452) are used to identify the entities involved in the query, the query conditions (455) define the logical constraints to be applied, and the aggregation operators (458) specify the data transformation operations to be performed on the retrieved records.

The graph traversal planner (460) receives the source and target tables (452) and uses the shortest path algorithm (462) to compute candidate paths through the relationship graph (408). The language model acting as the action planner (465) evaluates the output of the shortest path algorithm (462) and generates the graph traversal logic (468). The graph traversal logic (468) defines the sequence of entities and relationships to be followed during query execution and is passed to the search processor (470).

The search processor (470) uses the graph traversal logic (468) and the query conditions (455) to perform an entity-specific database search (472). The entity-specific database search (472) retrieves records from the relevant entities and produces the aggregate records (475). The aggregate records (475) represent the result set obtained by executing the query logic across the schema-defined entities.

The aggregate records (475) are passed to the language model acting as the text summarizer (482) and the language model acting as the visualization generator (492). The language model acting as the text summarizer (482) processes the aggregate records (475) and the aggregation operators (458) to generate the text response (485). The language model acting as the visualization generator (492) processes the same inputs to generate the plot response (495). The text response (485) provides a human-readable summary of the retrieved data, and the plot response (495) provides a visual representation of the data in accordance with the user's query.

The components of FIG. 4, including the query deconstructor (450), the graph traversal planner (460), the search processor (470), the text summarizer (482), and the visualization generator (492), operate in a manner similar to corresponding components of FIG. 3. FIG. 4 includes the embeddings (418) and the retriever (430) to enables the system of FIG. 4 to dynamically adapt to large and complex schema environments by retrieving relevant schema fragments for each query. The architecture allows the system to scale beyond the prompt length limitations of the language model while maintaining accurate and contextually grounded query generation.

Turning to FIG. 5, the user interface (500) is an example configured to support natural language interaction with a structured data retrieval system operating over a schema-based data environment. The user interface (500) includes an input window (510) that receives a user query expressed in natural language. The input window (510) is configured to accept free-form text input and may be implemented as a text box, chat interface, or other graphical input element. The user query entered in the input window (510) is processed by a query processing engine, which interprets the query using schema definitions and relationship graph schema to generate a structured query. The structured query is deconstructed to extract a source table, a target table, a query condition, and an aggregation operator. A traversal path is computed across a relationship graph based on the source table and the target table, and a set of entity-specific queries is executed using the query condition and the traversal path to retrieve records from a database.

The output window (520) displays the results of the query processing. The output window (520) includes a text summary (522) generated by a language model executing a summarization prompt. The text summary (522) provides a natural language description of the retrieved records and may include statistical information, record counts, or other descriptive content. The output window (520) further may include a table (525) that presents a structured view of the retrieved records. The table (525) includes columns such as ‘WellName’, ‘WellboreName’, ‘Curves’, etc., based on the type of entity that has been summarized and displays a sample of the records retrieved in response to the user query. The output window (520) also includes a list (528) of the retrieved records like well log set records, well records, production records etc., which may be extracted from the retrieved records and presented as a separate visual element to facilitate user navigation or inspection.

The user interface (500) includes a subsequent input window (550) that enables the user to enter follow-up queries. The subsequent input window (550) supports multi-turn interaction by allowing the user to refine, extend, or contextualize the original query. The system may incorporate conversational context from the prior query and response into the processing of the follow-up query, enabling continuity across multiple interactions.

The user interface (500) further includes a entity specific viewer (580) that is dynamically rendered based on the type of the retrieved records like map viewers, log viewers, well trajectory viewers, custom viewers etc. The log viewer (580) is selected based on the type of table from which the retrieved records originated. A viewer selection instruction may be generated by a language model based on the table type, and the log viewer (580) is invoked to display well log data in a graphical format. The log viewer (580) enables domain-specific visualization of structured data and supports interactive exploration of well log records retrieved in response to the user query.

Turning to FIG. 6, the user interface (600) is an example configured to support natural language interaction with a structured data retrieval system that includes automated visualization generation based on retrieved records. The user interface (600) includes the input window (610) that receives a user query expressed in natural language. The input window (610) is configured to accept free-form text input and may be implemented as a text box, chat interface, or other graphical input element. The user query entered in the input window (610) is processed by a query processing engine, which interprets the query using schema definitions and relationship graph schema to generate a structured query. The structured query is deconstructed to extract a source table, a target table, a query condition, and an aggregation operator. A traversal path is computed across a relationship graph based on the source table and the target table, and a set of entity-specific queries is executed using the query condition and the traversal path to retrieve records from a database.

The output window (620) displays the results of the query processing. The output window (620) includes a text response (622) generated by a language model executing a summarization prompt. The text response (622) provides a natural language description of the retrieved records and may include references to the visualization generated in response to the user query. The output window (620) further includes a link (625) labeled “plot” that, when selected, executes visualization code generated by a language model and renders the resulting plot in the plot view (680). The output window (620) also includes a table (628) that presents the structured data used to generate the plot view (680). The table (628) includes time-series production data such as oil and gas volumes associated with a specified wellbore and is formatted to support downstream visualization.

The user interface (600) includes a subsequent input window (650) that enables the user to enter follow-up queries. The subsequent input window (650) supports multi-turn interaction by allowing the user to refine, extend, or contextualize the original query. The system may incorporate conversational context from the prior query and response into the processing of the follow-up query, enabling continuity across multiple interactions.

The user interface (600) further includes the plot view (680) that is dynamically rendered based on the retrieved records and the visualization code generated by a language model executing a visualization prompt. The plot view (680) displays a production curve. Other types of charts and curves may be displayed in the plot view (680). The plot view (680) includes a title indicating the subject of the visualization, axis labels such as “Production date,” “Oil volume (cubic meters),” and “Gas volume (cubic meters),” and two curves representing oil and gas production volumes over time. The plot view (680) is configured to display the rolling average of oil production on a first axis and the gas production on a secondary axis, as specified in the user query. The visualization code used to generate the plot view (680) may be dynamically created by the language model based on the structure and content of the retrieved records and the aggregation operator. The plot view (680) enables domain-specific visualization of structured time-series data and supports interactive exploration of production trends retrieved in response to the user query.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 7.1, the computing system (700) may include one or more computer processor(s) (702), non-persistent storage device(s) (704), persistent storage device(s) (706), a communication interface (708) (e.g., Bluetooth interface, infrared interface, network interface, optical interface, etc.), and numerous other elements and functionalities that implement the features and elements of the disclosure. The computer processor(s) (702) may be an integrated circuit for processing instructions. The computer processor(s) (702) may be one or more cores, or micro-cores, of a processor. The computer processor(s) (702) includes one or more processors. The computer processor(s) (702) may include a central processing unit (CPU), a graphics processing unit (GPU), a tensor processing unit (TPU), combinations thereof, etc.

The input device(s) (710) may include a touchscreen, keyboard, mouse, microphone, touchpad, electronic pen, or any other type of input device. The input device(s) (710) may receive inputs from a user that are responsive to data and messages presented by the output device(s) (712). The inputs may include text input, audio input, video input, etc., which may be processed and transmitted by the computing system (700) in accordance with one or more embodiments. The communication interface (708) may include an integrated circuit for connecting the computing system (700) to a network (not shown) (e.g., a local area network (LAN), a wide area network (WAN), such as the Internet, mobile network, or any other type of network) or to another device, such as another computing device, and combinations thereof.

Further, the output device(s) (712) may include a display device, a printer, external storage, or any other output device. One or more of the output device(s) (712) may be the same or different from the input device(s) (710). The input device(s) (710) and output device(s) (712) may be locally or remotely connected to the computer processor(s) (702). Many different types of computing systems exist, and the aforementioned input device(s) (710) and output device(s) (712) may take other forms. The output device(s) (712) may display data and messages that are transmitted and received by the computing system (700). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium, such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (702), is configured to perform one or more embodiments, which may include transmitting, receiving, presenting, and displaying data and messages described in the other figures of the disclosure.

The computing system (700) in FIG. 7.1 may be connected to, or be a part of, a network. For example, as shown in FIG. 7.2, the network (720) may include multiple nodes (e.g., node X (722) and node Y (724), as well as extant intervening nodes between node X (722) and node Y (724)). Each node may correspond to a computing system, such as the computing system shown in FIG. 7.1, or a group of nodes combined may correspond to the computing system shown in FIG. 7.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (700) may be located at a remote location and connected to the other elements over a network.

The nodes (e.g., node X (722) and node Y (724)) in the network (720) may be configured to provide services for a client device (726). The services may include receiving requests and transmitting responses to the client device (726). For example, the nodes may be part of a cloud computing system. The client device (726) may be a computing system, such as the computing system shown in FIG. 7.1. Further, the client device (726) may include or perform all or a portion of one or more embodiments.

The computing system of FIG. 7.1 may include functionality to present data (including raw data, processed data, and combinations thereof), such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A computer-implemented method for retrieving and processing structured data in response to a natural language query, the method comprising:
constructing, by a language model executing a relationship graph construction prompt, a relationship graph representing entity relationships among a set of tables in a database based on a plurality of schema definitions;
generating, by the language model executing a query construction prompt, a structured query based on the natural language query and the plurality of schema definitions;
deconstructing the structured query to extract a source table of the set of tables, a target table of the set of tables, a query condition, and an aggregation operator;
determining, by the language model executing an action planning prompt, a traversal path across the relationship graph based on the source table and the target table;
executing a set of entity-specific queries using the query condition and the traversal path to retrieve records from the database; and
generating, by the language model executing an output prompt, a response based on the retrieved records and the aggregation operator, the response comprising one or more of a textual summary and a visualization based on the output prompt.

2. The method of claim 1, further comprising embedding the plurality of schema definitions and relationship graph in a vector database prior to constructing the relationship graph.

3. The method of claim 1, further comprising retrieving a subset of relevant schema definitions in the plurality of schema definitions from a vector database using a retriever module prior to generating the structured query.

4. The method of claim 1, further comprising identifying, by the language model, a conversational context from prior user queries and incorporating the conversational context into the structured query.

5. The method of claim 1, further comprising validating the traversal path by the language model based on domain-specific constraints derived from the plurality of schema definitions.

6. The method of claim 1, further comprising generating, by the language model, a sequence of subqueries corresponding to the set of entity-specific queries.

7. The method of claim 1, further comprising transforming the structured query into a format compatible with a non-relational search engine.

8. The method of claim 1, further comprising generating, by the language model, executable code that performs a data transformation operation on the retrieved records, the data transformation operation comprising one or more of filtering, grouping, aggregating, and smoothing.

9. The method of claim 1, further comprising generating, by the language model, a viewer selection instruction based on a type of table from which the retrieved records originated.

10. The method of claim 1, further comprising presenting a plot of the retrieved records, wherein the plot is generated from visualization code produced by the language model executing a visualization prompt included in the output prompt.

11. A system comprising:
at least one computer processor; and
an application that, when executing on the at least one computer processor, performs operations comprising:
constructing, by a language model executing a relationship graph construction prompt, a relationship graph representing entity relationships among a set of tables in a database based on a plurality of schema definitions,
generating, by the language model executing a query construction prompt, a structured query based on a natural language query and the plurality of schema definitions,
deconstructing the structured query to extract a source table of the set of tables, a target table of the set of tables, a query condition, and an aggregation operator,
determining, by the language model executing an action planning prompt, a traversal path across the relationship graph based on the source table and the target table,
executing a set of entity-specific queries using the query condition and the traversal path to retrieve records from the database, and
generating, by the language model executing an output prompt, a response based on the retrieved records and the aggregation operator, the response comprising one or more of a textual summary and a visualization based on the output prompt.

12. The system of claim 11, wherein the application performs operations further comprising embedding the plurality of schema definitions and relationship graph in a vector database prior to constructing the relationship graph.

13. The system of claim 11, wherein the application performs operations further comprising retrieving a subset of relevant schema definitions in the plurality of schema definitions from a vector database using a retriever module prior to generating the structured query.

14. The system of claim 11, wherein the application performs operations further comprising identifying, by the language model, a conversational context from prior user queries and incorporating the conversational context into the structured query.

15. The system of claim 11, wherein the application performs operations further comprising validating the traversal path by the language model based on domain-specific constraints derived from the plurality of schema definitions.

16. The system of claim 11, wherein the application performs operations further comprising generating, by the language model, a sequence of subqueries corresponding to the set of entity-specific queries.

17. The system of claim 11, wherein the application performs operations further comprising transforming the structured query into a format compatible with a non-relational search engine.

18. The system of claim 11, wherein the application performs operations further comprising generating, by the language model, executable code that performs a data transformation operation on the retrieved records, the data transformation operation comprising one or more of filtering, grouping, aggregating, and smoothing.

19. The system of claim 11, wherein the application performs operations further comprising generating, by the language model, a viewer selection instruction based on a type of table from which the retrieved records originated.

20. A non-transitory computer readable medium comprising instructions executable by at least one computer processor to perform:
constructing, by a language model executing a relationship graph construction prompt, a relationship graph representing entity relationships among a set of tables in a database based on a plurality of schema definitions;
generating, by the language model executing a query construction prompt, a structured query based on a natural language query and the plurality of schema definitions;
deconstructing the structured query to extract a source table of the set of tables, a target table of the set of tables, a query condition, and an aggregation operator;
determining, by the language model executing an action planning prompt, a traversal path across the relationship graph based on the source table and the target table;
executing a set of entity-specific queries using the query condition and the traversal path to retrieve records from the database; and
generating, by the language model executing an output prompt, a response based on the retrieved records and the aggregation operator, the response comprising one or more of a textual summary and a visualization based on the output prompt.
